(19) United States
(12) Patent Application Publication
(10) Pub. No.: US 2006/0029133 A1
(43) Pub. Date: Feb. 9, 2006

(54) System and method for bit-plane decoding of fine-granularity scalable (fgs) video stream

(76) Inventor: Richard Y Chen, Croton-On-Hudson, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/539,384

(22) PCT Filed: Dec. 12, 2003
(86) PCT No.: PCT/IB03/05909

§ 371 Date: Jun. 15, 2005

(30) Foreign Application Priority Data
Dec. 16, 2002 (US) 60433744

(51) Int. Cl. H04N 7/12; H04B 1/66; H04N 11/02; H04N 11/04

(52) U.S. Cl. 375/240.08; 375/240.2; 375/240.12

(57) ABSTRACT

A method of inverse transform of bit-plane-oriented discrete cosine transform transformed data representing the enhancement layer of a frame of video date encopoded in a fine granularscability comprising: providing a lookup table comprissing a mtrix of numerical contributions based on location of a bit-plane cell within any bit-plane of a bit-plane set, the numerical contributions independent of bit-plane order; selecting the numerical contribution from the lookup table for each bit-plane cell having a discrete cosine transform coefficient od 1 in each bit-plane; and shifting a binary representation of each selected numerical contribution by number of bit-positions equal to a bit-plane number of the bit-plane of which a particular bit-plane cell is a menber.

The present invention relates to the field of processing transform-coded data, more specifically, it relates to an apparatus and method of inverse discrete cosine transform (IDCT) of bit-plane-orientated data.

Fine Granular Scalability (FGS) has been adopted into the Motion Pictures Expert Group (MPEG) 4 coding standard for the distribution of video over heterogeneous networks. However, the two-layer structure of FGS requires greater and more complex data processing of the data streams carrying MPEG-4 FGS data.

This increased complex processing requires increased amounts of microprocessor processing time, increased memory and increased hardware complexity when conventional data processing algorithms and methodologies are applied. These requirements add costs and are prohibitive in certain small device applications

Therefore, there is a need in the industry for a processing algorithm and methodology that decreases one or more of microprocessor time, memory size and hardware complexity required to process MPEG-4 FGS data streams.

A first aspect of the present invention is a method of inverse transform of bit-plane-oriented discrete cosine transform transformed data representing a frame of video data comprising: providing a lookup table comprising a matrix of numerical contributions based on a location of a bit-plane cell within any bit-plane of a bit-plane set, the numerical contributions independent of bit-plane order; selecting the numerical contribution from the lookup table for each bit-plane cell having a discrete cosine transform coefficient of 1 in each bit-plane; and shifting a binary representation of each selected numerical contribution by a number of bit-positions equal to a bit-plane number of the bit-plane of which a particular bit-plane cell is a member.

A second aspect of the present invention is a fine granular scalability decoder comprising: an enhancement layer decoder comprising: a fine granular scalability bit-plane variable length decoder adapted to receive and decode a fine granular scalability enhancement stream; a bit-plane inverse discrete cosine transform processor coupled to an output of the fine granular scalability bit-planer variable length decoder and adapted to create enhancement frame data; and an enhanced video reconstructor coupled to a frame buffer and adapted to combine the enhancement frame data with frame data to produce an enhanced video signal; and a base layer decoder adapted to decode a base layer stream into the base video signal.

A third aspect of the present invention is a fine granular scalability decoder comprising: an enhancement layer decoder comprising: a fine granular scalability bit-plane variable length decoder adapted to receive and decode a fine granular scalability enhancement stream; a bit-plane inverse discrete cosine transform processor coupled to an output of the fine granular scalability bit-planer variable length decoder and adapted to create enhancement frame data; and an enhanced video reconstructor coupled to a frame buffer and adapted to combine the enhancement frame data with a base video signal to produce an enhanced video signal; and a base layer decoder adapted to decode a base layer stream into the base video signal.

The features of the invention are set forth in the appended claims. The invention itself, however, will be best understood by reference to the following detailed description of an illustrative embodiment when read in conjunction with the accompanying drawings, wherein:

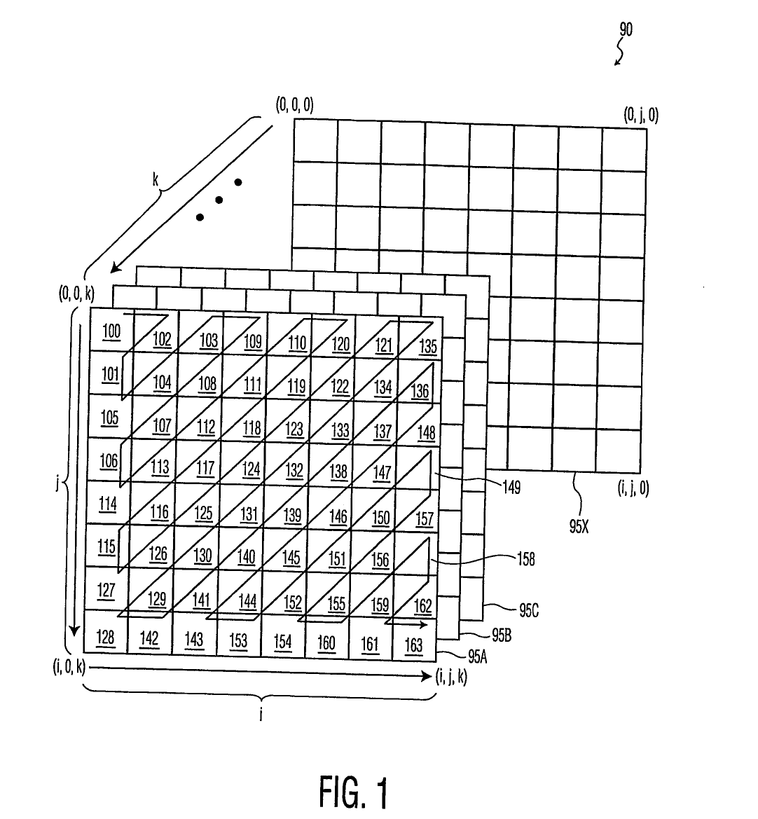

FIG. 1 is schematic diagram of a set of bit-planes according to the present invention;

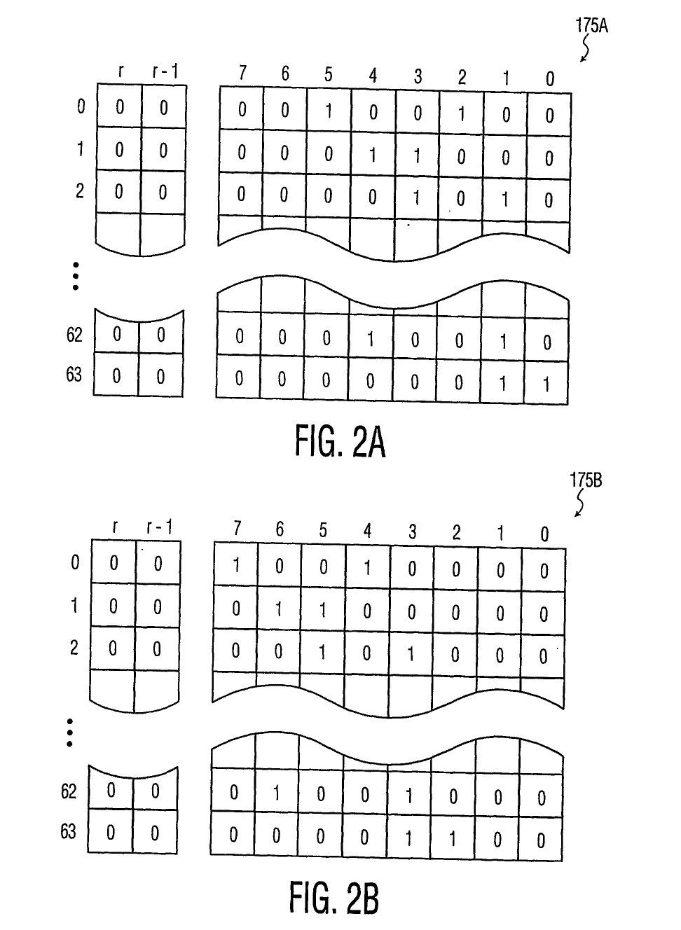

FIG. 2A is a schematic diagram of an exemplary matrix of values obtained from inverse transforming a single block of frequency data from the k=2 bit-plane illustrated in FIG. 1 according to the present invention;

FIG. 2B is a schematic diagram of the exemplary matrix of FIG. 2A after an exemplary shift operation according to the present invention;

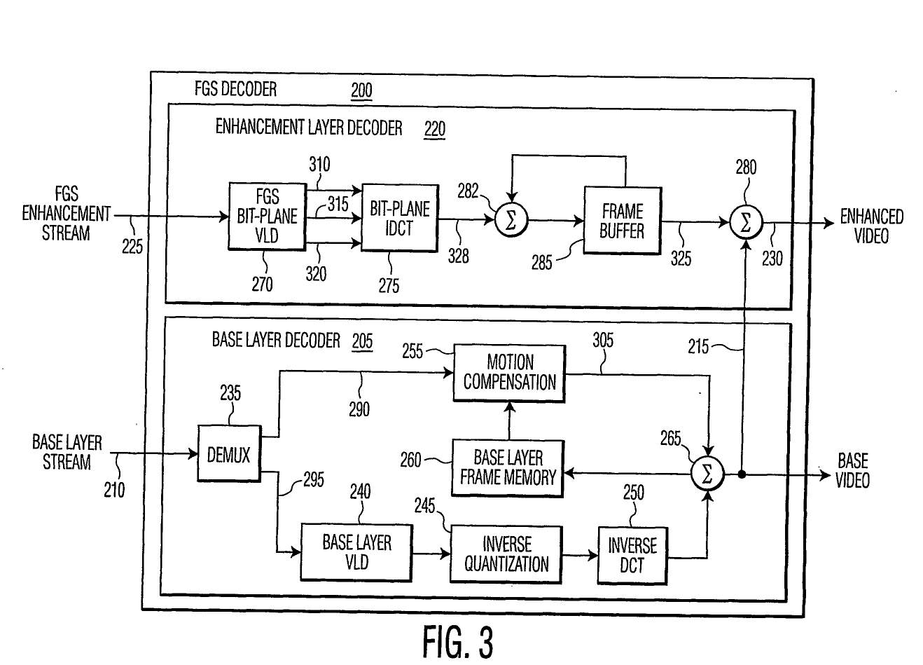

FIG. 3 is schematic block diagram of a decoder according to the present invention;

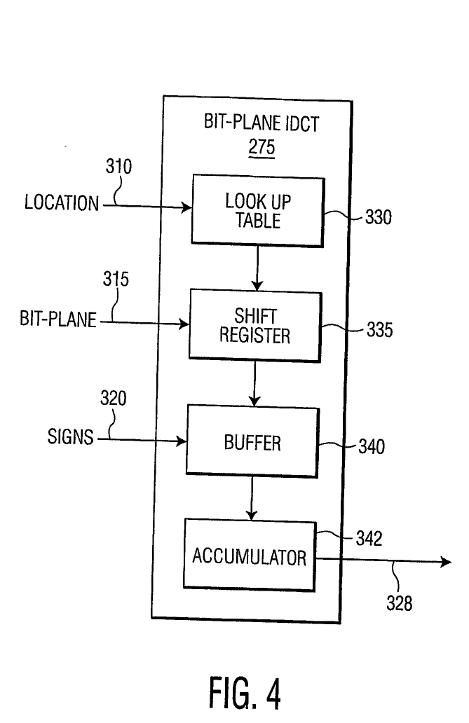

FIG. 4 is a schematic block diagram of a bit-plane IDCT processor according to the present invention; and

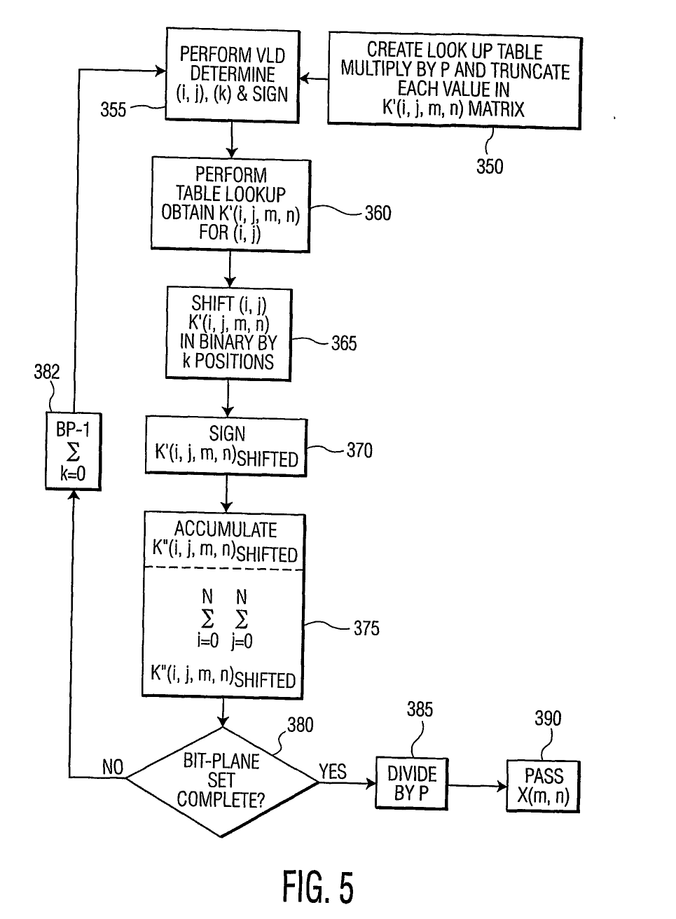

FIG. 5 is a flowchart of the method of the bit-plane IDCT for inverse transform of bit-plane-oriented DCT data for decoding an FGS enhancement stream according to the present invention.

In the present invention, the two-layer FGS structure includes a motion compensation-based base-layer stream encoded at relatively low data rate Rb using a discrete cosine transform (DCT) compression and an enhanced layer stream encoded to a relatively high maximum bit rate Rₘₐₓ−R_{b} and compressed with a bit-plane-based DCT. In one example, R_{b}=100 kilobits/sec(kbps), Rₘₐₓ=11000 kbps, and the scale levels are 100-kbps apart, i.e. 100, 200, 400, 300, 400 . . . 1000.

The MPEG-4 FGS implementation encodes the enhancement layer as the DCT transform of the pixel difference (residual) between the original picture and the reconstructed base layer. Further, the enhancement-layer is coded progressively (bit-plane by bit-plane) employing an embedded DCT coding scheme. In a progressive coder, the more significant bit-planes are transmitted before the less significant bit-planes. The most significant bit-planes (MSB) are coded first, followed by the less significant bit-planes (LSB). Each DCT bit-plane is divided into DCT bit-plane cells. The run length of 0's before each 1 in each bit-plane cell is entropy-coded into the 0's and 1's of a variable length code (VLC), so each VLC represents a 1 within a DCT bit-plane cell a in a specific bit-plane of an enhancement frame. All the VLCs from all the DCT bit-plane cells in all the coded bit-planes constitute the compressed enhanced stream.

In an FGS scheme, scalability is achieved by encoding the data using a range of bandwidth between R_{b} and Rₘₐₓ but decoding the data stream at one of a number of discrete scale levels up to the maximum bit-rate.

In general, a DCT takes a block of N1×N2 video pixel data (generally a video frame is made up of multiple N1×N2 blocks) expressed as a numbers of the magnitude of the property of the pixel being transformed (for example, brightness) in pixel domain (a two dimensional matrix) and converts the N1×N2 block of video pixel to a set of k N1×N2 DCT blocks (a three dimensional matrix) containing DCT coefficients in frequency domain. Each DCT block contains only 0's or 1's. The binary presentation of each DCT coefficient comprises k bits of 0's and 1's. The k bits are distributed across DCT blocks, thus the r^{th} bit for all the coefficients in all the N1×N2 DCT blocks that make up a whole frame in frequency domain forms the r^{th} bit-plane.

FIG. 1 is schematic diagram of a set of bit-planes according to the present invention. In FIG. 1, a DCT block (a set of frequency coefficients from the DCT transform) is represented by a bit-plane set 90, which includes a multiplicity of bit-planes 95A, 95B, 95C through 95X. Thus each DCT block consists of a number BP of bit-planes each bit-plane having been scanned in a zigzag pattern 98 starting from the most significant bit-plane (k BP-1) and ending at the least significant bit-plane (k=0). There are BP bit-planes, bit-plane 95A corresponding to bit-plane k=BP-1 (the most significant bit-plane), bit-plane 95B corresponding to k=BP-2, bit-plane 95C corresponding k=BP-3 through bit-plane 95X corresponding to k=0. In the present example BP=12, so there are twelve bit-planes 95A, 95B, 95C through 95X. The number of bit-planes (k) is determined by the maximum value that the transform coefficients can have. Only one bit-plane set of one of many DCT blocks that make up a frequency domain video frame is illustrated. Each bit-plane contains only 0's and 1's.

Each bit-plane 95A, 95B, 95C through 95X is an 8×8 square matrix of bit-plane cells 100 through 163 having indices (i, j). (In this example, N1=N2=N=8). The indices of bit-plane cell 100 are (0, 0), of bit-plane cell 128 are (7, 0), of bit-plane cell 135 are (0, 7) and of bit-plane cell 163 are (7, 7). Each bit-plane cell 100 through 163 contains a 0 or a 1.

The following discussion focuses on one block of a video frame to illustrate the operations, although the IDCT transform is applied repeated from block to block traversing the whole video frame.

The equation for bit-plane decomposition is given by:

$${C}_{x} ( i , j ) = {\sum }_{k = 0}^{BP - 1} {c ( i , j )}_{k} * {2}^{k} \qquad ( 1 )$$

where:
Cₓ (i, j) is the DCT coefficient at cells (i, j) in frequency domain;
BP=the number of bit-planes (in the present example 12); and
c(i, j)ₖ is the DCT bit value (0 or 1) of a bit-plane cell (i, j) of bit-plane (k) with associated mathematical sign.

The Inverse DCT (IDCT) transform for an N×N block is given by:

$$X ( m , n ) = \frac{1}{{N}^{2}} {\sum }_{i = 0}^{N} {\sum }_{j = 0}^{N} u ( i ) u ( j ) {C}_{x} ( i , j ) cos \frac{( 2 m + 1 ) i}{2 N} * cos \frac{( 2 n + 1 ) j}{2 N} \qquad ( 2 )$$

where:
X(m, n) is the pixel value at location (m, n) in an N×N matrix in pixel domain;
N is the block dimension of each bit-plane (8 in the present example);
u(i)=0.5 when i=0 and 1 when i γ 0; and
u(j) 0.5 when j=0 and 1 when j γ0.

Substituting equations (1) into equation (3):

$$X ( m , n ) = {\sum }_{k = 0}^{BP - 1} [ \frac{1}{{N}^{2}} {\sum }_{i = 0}^{N} {\sum }_{j = 0}^{N} u ( i ) u ( j ) cos \frac{( 2 m + 1 ) i}{2 N} * \\ cos \frac{( 2 n + 1 ) j}{2 N} * {2}^{k} {c ( i , j )}_{k} ] \qquad ( 3 )$$

c(i, j)ₖ can have only two values 0 or 1. The contribution of a 0 in bit-plane cell (i, j) of bit-plane (k) to X(m, n) is zero because c(i, j)ₖ=0. The contribution of a 1 in bit-plane cell (i, j) of bit-plane (k) to X(m, n) for each combination of (m, n) is:

$$\begin{matrix}{Z ( i , j , m , n )}_{k} = \frac{1}{{N}^{2}} u ( i ) u ( j ) cos \frac{( 2 m + 1 ) i}{2 N} * cos \frac{( 2 n + 1 ) j}{2 N} * {2}^{k} & ( 4 ) \\ Defining K ( i , j , m , n ) = \frac{1}{{N}^{2}} u ( i ) u ( j ) cos \frac{( 2 m + 1 ) i}{2 N} * cos \frac{( 2 n + 1 ) j}{2 N} & ( 5 )\end{matrix}$$

K(i, j, m, n) is a matrix of values independent of (k) and of dimension N×N for each (m, n). Therefore, K(i, j, m, n) is the same for all bit-planes (k). With N=8, there are 64 individual values of K(i, j, m, n) Since all the values on the right hand side of equation (5) are known, K(i, j, m, n) can be calculated for every combination (i, j, m, n). Substituting equation (5) into equation (4):
Z(i, j, n, m)ₖ=K(i, j, n, m)*2^{k} (6)

The value of a given pixel X(m, n) is the sum of the contributions of 1's in the corresponding 12 bit-plane cells (i, j)ₖ of each bit-plane. By substituting equation (5) into equation (3), X(m, n) may be expressed as:

$$X ( m , n ) = {\sum }_{k = 0}^{BP - 1} {\sum }_{i = 0}^{N} {\sum }_{j = 0}^{N} K ( i , j , m , n ) * {2}^{k} \qquad ( 7 )$$

The individual (i, j) values of K(i, j, m, n) can be pre-computed and stored in a matrix or lookup table. Since cosine functions generally result in floating point numbers, the K(i, j, m, n) matrix is multiplied by a constant factor P and truncated to so subsequent operations need only deal with integers. Thus what is stored is K′(i, j, m, n)=P*K(i, j, m, n). In one example, P=1024 and the mantissa portion of each number dropped. In the present example K′(i, j, m, n) is stored in an 8×8 look-up table. To determine the value of a given X(m, n) the value of the DCT coefficient at the corresponding (i, j) for each bit-plane (k) is determined. Remembering that a DCT coefficient of zero contributes nothing to X(m, n) and that K(i, j, m, n) contains the contributory values for DCT coefficients of one, the corresponding K′(i, j, m, n) value from the lookup table is determined and represented, for example, as a multiple bit word in a 64 (8×8=64) word register. The words are then shifted to the left (the leftmost position being the most significant bit position) by the number of bits corresponding to the (k) value of the bit-plane plane. Shifting is illustrated in FIGS. 2A and 2B and discussed infra. Each location (i, j) has either a mathematical positive sign or negative sign associated with it. The value of the sign is decoded right after the most significant 1 in the location (i, j) is decoded. If the sign is negative, 2's complement is performed to all the 64 words before they are summed into a 64-word accumulator/buffer. This is repeated for all bit-planes, in the present example using

$${\sum }_{k = 0}^{11} {\sum }_{i = 0}^{7} {\sum }_{j = 0}^{7}$$

(see equation 7), to produce X′(m, n).

Finally the resultant X′(m, n) is divided by P to obtain X(m, n). Note that in the example supra, P=1024 which is 2^{p} where p=10). Since X′(m, n) is a positive integer, a simple shift of X′(m, n), expressed in binary, of 10 bit positions to the right is all that is required to produce X(m, n). No real-time multiplications are required, but only much faster shift operations. In one example, a shift operation requires 2 central processing unit (CPU) cycles while a multiplication requires 17 CPU cycles. Since the complexity and the amount of time needed to perform the calculations is proportional to the bit-rate of the enhanced layer stream the algorithm of the present invention is ideally suited to FGS.

FIG. 2A is a schematic diagram of an exemplary matrix of values obtained from inverse transforming a single block of frequency data from the k=2 bit-plane illustrated in FIG. 1 according to the present invention. In FIG. 2A, register 175A is arranged in 64 r-bit words as illustrated. There are 64 words because there are 8×8=64 cells in each bit-plane in the present example. The number of bits r is a function of the magnitude of the largest number in X(m, n), the value of k, and the value of P. The register must be wide enough (i.e. the value of r) to accept the largest binary value possible for K′(i, j, m, n,) after shifting by p position (multiplying by P) and further shifting by k=BP-1 positions without bits being dropped off the left side of the register. Register 175A is illustrated containing the K′(i, j, m, n) matrix obtained by a lookup operation as discussed supra, for all 64 cells (i, j) of the k=2 bit-plane. Word 0 contains 1s in the 3rd and 6th bit positions representing a value of 36. Word 1 contains 1s in the 4th and 5th bit positions representing a value of 24. Word 2 contains 1s in the 2nd and 4th bit positions representing a value of 10. Word 62 contains 1s in the 2nd and 5th bit positions representing a value of 18. Word 63 contains 1s in the 2nd and 3rd bit positions representing a value of 3.

FIG. 2B is a schematic diagram of the exemplary matrix of FIG. 2A after an exemplary shift operation according to the present invention. In FIG. 2B, register 175B all the bits have been shifted 2 bit positions to the left, the equivalent of multiplying by 2^{k} where k=2). Word 0 now contains 1s in the 5th and 8th bit positions representing a value of 144. Word 1 now contains is in the 6th and 7th bit positions representing a value of 96. Word 2 now contains 1 s in the 4th and 6th bit positions representing a value of 40. Word 62 now contains is in the 4th and 7th bit positions representing a value of 72. Word 5 now contains 1s in the 3rd and 4th bit positions representing a value of 12. If the bit-plane had been k=3 then every bit in every word would have been shifted by 3 bit-positions to the left, in effect, multiplying by 23 or 8.

In the present example of 12 bit-planes, there would be twelve cycles performed, the result of each cycle accumulated in an accumulator/buffer. Each cycle includes obtaining the K′(i, j, m, n) matrix from the lookup table and shifting the matrix as described supra, adding the proper sign (illustrated in FIG. 5 and described infra) and accumulated in a local buffer/accumulator, transfer the result to the video buffer where the result is accumulated over the all the bit-planes, and shifted by p positions to the right. It should be understood that each X(i, j, m, n) has an associated arithmetic sign (positive or negative). These signs must be added prior to the triple summation being performed. Accumulating the twelve cycles performs the triple sum:

$${\sum }_{k = 0}^{11} {\sum }_{i = 0}^{7} {\sum }_{j = 0}^{7}$$

(see equation 7). Shifting by p positions to the right is equivalent to dividing by P. This particular aspect of the invention is discussed infra in relation to FIGS. 3, 4 and 5.

FIG. 3 is schematic block diagram of a decoder according to the present invention. In FIG. 3, an FGS decoder 200 includes a base-layer decoder 205 for receiving a base layer stream 210 and outputting a base video signal 215 and an enhancement layer decoder 220 for receiving an FGS enhancement stream 225 and outputting an enhanced video signal 230. Base layer decoder 205 includes a de-multiplexer 235, a base layer variable length decoder (VLD) 240, an inverse quantizer 245, an IDCT processor 250, a motion compensator 255, base layer frame memory 260 and a base video reconstructor 265. Enhancement layer decoder 220 includes a FGS bit-plane VLD 270, a bit-plane IDCT processor 275, an enhanced video reconstructor 280 and an accumulator 282 and a frame buffer 285.

Base layer decoder 205 operates as follows: de-multiplexer 235 receives base layer stream 210 and outputs motion vector (MV) data 290 to motion compensator 255 and outputs compressed base layer DCT data 295 to base layer VLD 240. Base layer VLD re-generates the base layer DCT residual, which are processed by inverse quantizer 245 and passed to IDCT processor 250. Inverse quantizer 245 undoes the quantization performed at the encoder. IDCT processor 250 performs an IDCT to generate residual frames data 300. Motion compensator 255 uses information contained in MV data 290 to compute compensated frame data 305 while base layer VLD 240, inverse quantizer 245 and IDCT processor 250 process base layer DCT data 295. Residual frames data 300 and base layer frames data 305 are added together by base video reconstructor 265, storing intermediate results in base layer frame memory 260, and generates base video signal 215. Base video signal 215 is sent to enhanced video reconstructor 280. Base video signal 215 is a displayable signal, i.e. it may be used directly by a display device to present a video picture to a viewer.

Enhancement layer decoder operates as follows: FGS bit-plane VLD 270 receives FGS enhancement stream 225 and decodes individual run-length codes (RLC). Each RLC resulting in a DCT coefficient of 1 in a specific bit-plane at a specific location produces a location signal 310, containing the (i, j) bit-plane cell location, a bit-plane signal 315, containing the (k) bit-plane that the bit-plane cell belongs to, and a sign signal 320 indicating whether the contribution should be added or subtracted are passed to bit-plane IDCT processor 275. IDCT processor 275 is illustrated in FIG. 4 and described infra. Bit-plane IDCT processor 275 performs the signing and the

$${\sum }_{i = 0}^{N - 1} {\sum }_{j = 0}^{N - 1}$$

summations, which are passed to accumulator 282 as a signal 328. Accumulator 282 performs the

$${\sum }_{k = 0}^{BP - 1}$$

summation and generates enhancement frame data 325. Enhancement frame data 325 and base frame data 215 are added together by enhanced video reconstructor 280, which generates enhanced video signal 230. Enhanced video signal 230 is a displayable signal.

FIG. 4 is a schematic block diagram of bit-plane IDCT processor 275 of FIG. 3. In FIG. 4, bit-plane IDCT processor 275 includes a lookup table 330, a shift register 335 (or similar device), a buffer 340 and an accumulator 342. Lookup table 330 includes a matrix of K(i, j, m, n) values (see equations 4 and 5 supra). Lookup table 330 receives location signal 310 and looks up the value of K′(i, j, m, n) in the corresponding (i, j) locations of the lookup table. This value is passed to shift register 335 where, expressed as a binary number it is shifted in response to bit-plane signal 315 as illustrated in FIGS. 2A and 2B and described supra, which is equivalent to performing the operation K′(i, j, m, n)*2^{k}. After the corresponding sign (+ or −) is assigned to each K′(i, j, m, n) in buffer 340, accumulator/buffer 342, accumulates the shifted K(i, j)_{SHIFTED} values, performing the double summation

$${\sum }_{i = 0}^{N - 1} {\sum }_{j = 0}^{N - 1}$$

transfer one bit-plane contribution to the frame buffer where the bit-plane contribution gets accumulated.

FIG. 5 is a flowchart of the method of inverse transform of bit-plane-oriented DCT data stream according to the present invention. In step 350, a look up table of K′(i, j, m, n), is created for a DCT coefficient of 1 in each (i, j) location of a bit-plane cell of any bit-plane. Lookup table of K′(i, j, m, n) is independent bit-plane (k). In step 355, a VLD is performed one RLC and the (i, j) location, the bit-plane (k) and a sign if it is the most the significant bit of the coefficient is determined. In step 360, a lookup is performed to determine one matrix K′(i, j, m, n) values. In step 365, each bit of each determined matrix K′(i, j, m, n) value expressed in binary is bit-shifted to a higher significant bit position by k bit positions. In step 370, the proper sign is attached to each K¹(i, j, m, n)_{SHIFTED} which produces K′(i, j, m, n)_{SHIFTED}. The resultant K″(i, j, m, n)_{SHIFTED} value is used to calculate the actual contribution of bit-plane location (i, j) X(m, n). In step, 375 K″ (i, j, m, n)_{SHIFTED} values are accumulated.

As the K″ (i, j, m, n)_{SHIFTED} values are accumulated the

$${\sum }_{i = 0}^{N} {\sum }_{j = 0}^{N}$$

summations are performed. If the bit-plane set is not complete, then the method loops to step 355 through step 382. It is this the looping between steps 380 and 355 that performs the

$${\sum }_{k = 0}^{BP - 1}$$

summation as additional VLCs are decoded. If the bit plane set is complete, then in step 385 X′(m, n) (in binary) is shifted by p positions to the right to produce X(m, n) and in step 390, with the reconstruction of X(m, n) complete, the block is passed out.

The method then is repeated for each set of bit-planes of a frame. For example, if the original frame was 320×240 pixels, then there are 40×30×1.5=1800 8×8 blocks (×1.5 to include chroma blocks) for that frame. The same lookup table is used for all blocks and all frames.

In step 380, it is determined if the bit-plane set of a block is complete.

The description of the embodiments of the present invention is given above for the understanding of the present invention. It will be understood that the invention is not limited to the particular embodiments described herein, but is capable of various modifications, rearrangements and substitutions as will now become apparent to those skilled in the art without departing from the scope of the invention. Therefore, it is intended that the following claims cover all such modifications and changes as fall within the true spirit and scope of the invention.

1. A method of inverse transform of bit-plane-oriented discrete cosine transform transformed data representing a frame of video data comprising:
providing a lookup table comprising a matrix of numerical contributions based on a location of a bit-plane cell within any bit-plane of a bit-plane set, said numerical contributions independent of bit-plane order;
selecting said numerical contribution from said lookup table for each bit-plane cell having a discrete cosine transform coefficient of 1 in each bit-plane; and
shifting a binary representation of each selected numerical contribution by a number of bit-positions equal to a bit-plane number of the bit-plane of which a particular bit-plane cell is a member.

2. The method of claim 1, wherein said lookup table is pre-calculated.

3. The method of claim 1, wherein said bit-planes numbers decrease from a most significant bit-plane to a least significant bit-plane.

4. The method of claim 1, wherein said shifting said binary representation shifts from a lower to a higher significant bit position.

5. The method of claim 1 further including adding over all bit-planes said actual contributions of each corresponding bit-plane cell of each bit-plane for each said coefficient to calculate said matrix of pixel values

6. The method of claim 5, further including assigning a mathematical positive or a mathematical negative to the said contributions.

7. The method of claim 1, wherein said frame of enhancement video data is decoded from an MPEG4 FGS enhanced data stream

8. A bit-plane inverse discrete cosine transform processor comprising:
a lookup table comprising a matrix of numerical contributions based on a location of a bit-plane cell within any bit-plane of a bit plane-set, said numerical contributions independent of bit-plane order;
means for selecting said numerical contribution from said lookup table for each bit-plane cell having a discrete cosine transform coefficient of 1 in each bit-plane; and
means for shifting a binary representation of each selected numerical contribution by a number of bit-positions equal to a bit-plane number of the bit-plane of which a particular bit-plane cell is a member.

9. The processor of claim 8, wherein said lookup table is pre-calculated.

10. The processor of claim 8, wherein said bit-planes numbers decrease from a most significant bit-plane to a least significant bit-plane.

11. The processor of claim 8, wherein said means for shifting said binary representation shifts from a lower to a higher significant bit position.

12. The processor of claim 8, further including means for adding over all bit-planes said actual contributions of each corresponding bit-plane cell of each bit-plane to obtain a matrix of pixel values.

13. The processor of claim 11, wherein said means for adding further comprises means for assigning a mathematical positive or a mathematical negative to said contributions.

14. A fine granular scalability decoder comprising:
an enhancement layer decoder comprising:
a fine granular scalability bit-plane variable length decoder adapted to receive and decode a fine granular scalability enhancement stream;
a bit-plane inverse discrete cosine transform processor coupled to an output of said fine granular scalability bit-planer variable length decoder and adapted to create enhancement frame data; and
an enhanced video reconstructor coupled to a frame buffer and adapted to combine said enhancement frame data with a base video signal to produce an enhanced video signal; and
a base layer decoder adapted to decode a base layer stream into said base video signal.

15. The decoder of claim 14, wherein said bit-plane inverse discrete cosine transform processor comprises:
a lookup table comprising a matrix of numerical contributions based on a location of a bit-plane cell within said any bit-plane of a bit-plane set, said numerical contributions independent of bit-plane order;
means for selecting a numerical contribution from said lookup table for each bit-plane cell having a discrete cosine transform coefficient of 1 in each bit-plane; and
means for shifting a binary representation of each selected numerical contribution by a number of bit-positions equal to a bit-plane number of the bit-plane of which a particular bit-plane cell is a member.

16. The decoder of claim 15, wherein said lookup table is pre-calculated.

17. The decoder of claim 15, wherein said bit-planes numbers decrease from a most significant bit-plane to a least significant bit-plane.

18. The decoder of claim 15, wherein said means for shifting said binary representation shifts from a lower to a higher significant bit position.

19. The decoder of claim 15, further including means for adding over all bit-planes said actual contributions of each corresponding bit-plane cell of each bit-plane to obtain a matrix of pixel values.

20. The decoder of claim 19, wherein said means for adding further comprises means for assigning a mathematical positive or a mathematical negative to the said contributions.

21. The decoder of claim 15, wherein said fine granular scalability bit-plane variable length decoder generates said location of said bit-plane cell within a particular bit-plane.

22. The decoder of claim 15, wherein said fine granular scalability bit-plane variable length decoder generates said bit-plane number of a particular bit-plane.

23. The decoder of claim 15, wherein said fine granular scalability bit-plane variable length decoder generates said mathematical positive or said mathematical negative.

24. The decoder of claim 14, wherein said base layer decoder includes an inverse discrete transform processor.

25. The decoder of claim 14, wherein said an enhancement layer decoder generates a zero value for every bit-plane cell of a missing bit-plane of said bit-plane set in said fine granular scalability enhancement stream.
